(19) United States
(12) Patent Application Publication
(10) Pub. No.: US 2025/0209970 A1
(43) Pub. Date: Jun. 26, 2025

(54) DISPLAY APPARATUS AND METHOD FOR DRIVING THE SAME

(71) Applicant: LG Display Co., Ltd., Seoul (KR)

(72) Inventor: Changseon GONG, Paju-si (KR)

(73) Assignee: LG Display Co., Ltd., Seoul (KR)

(21) Appl. No.: 18/903,299

(22) Filed: Oct. 1, 2024

(30) Foreign Application Priority Data
Dec. 20, 2023 (KR) 10-2023-0187095

(51) Int. Cl. G09G 3/32

(52) U.S. Cl. CPC G09G 3/32; G09G 2320/0257; G09G 2320/0271; G09G 2330/023

(57) ABSTRACT

A display apparatus may include: a display panel including a plurality of sub-pixels, a driver circuit configured to driving the display panel, and a sensing circuit for sensing electrical characteristics of a sensing area of display panel to output sensing data. The driver circuit may perform a sequence that varies sensing current applied to a first power line until the sensing data falls within a target range in a sensing mode, and repeat the sequence with respect to the sensing area. A method for driving a display apparatus is also disclosed.

### CROSS-REFERENCE TO RELATED APPLICATIONS

This application claims the benefit of and priority to Korean Patent Application No. 10-2023-0187095 filed on Dec. 20, 2023, the entire contents of which are incorporated herein by reference for all purposes as if fully set forth herein.

### BACKGROUND

### 1. Technical Field

The present disclosure relates to a display apparatus, and particularly to, for example, without limitation, a display apparatus for afterimage compensation.

### 2. Discussion of the Related Art

Electroluminescence display devices have the advantages of high luminance, low driving voltage, ultra-thinness, and implementation of free shape by using self-emitting element.

To ensure long-term performance and reliability, electroluminescence display apparatus may compensate for afterimages by sensing and measuring the electrical characteristics of the light emitting element as it deteriorates.

The electroluminescence display apparatus may sense electrical characteristics of the sensing sub-pixel through a power line shared by the sensing sub-pixel and the non-sensing sub-pixel.

In an electroluminescence display apparatus, leakage current flowing through the non-sensing sub-pixels may cause sensing errors in the electrical characteristics of the sensing sub-pixels, which may distort the afterimage compensation.

The description of the related art should not be assumed to be prior art merely because it is mentioned in or associated with this section. The description of the related art includes information that describes one or more aspects of the subject technology, and the description in this section does not limit the invention.

### SUMMARY

An aspect of the present disclosure is directed to providing a display apparatus and a method of driving the same that may improve afterimage compensation performance by minimizing the effect of leakage current, thereby improving sensing accuracy for electrical characteristics of a light emitting element.

The problems to be solved by embodiments of the present disclosure are not limited to those mentioned above, and other problems not mentioned above will be apparent to those skilled in the art to which the technical ideas of the present disclosure belong from the following descriptions.

A display apparatus according to an example embodiment of the present disclosure comprises: a display panel including a plurality of sub-pixels, a driver circuit configured to drive the display panel, and a sensing circuit for sensing electrical characteristics of a sensing area of display panel to output sensing data, wherein the driver circuit is configured to perform a sequence that varies sensing current applied to a first power line until the sensing data falls within a target range in a sensing mode, and repeats the sequence with respect to the sensing area.

A driving method of a display apparatus according to an example embodiment of the present disclosure comprises: sensing a sensing area of display area using first sensing current according to a first sensing sequence, determining whether first sensing data is distorted by comparing the first sensing data sensed according to the first sensing sequence of present sensing mode and previous sensing data of previous sensing mode, varying the first sensing current to the second sensing current, in response to determining that the first sensing data is distorted, sensing the sensing area of the display area using the second sensing current according to the second sensing sequence, and repeating a process of determining whether the second sensing data is distorted by comparing the second sensing data sensed according to the second sensing sequence and previous sensing data of previous sensing mode, and calculating a compensate gain for change of electrical characteristics of sensing sub-pixels in the sensing area based on the sensing data, which is determined to be normal and storing the compensate gain in memory, in response to the first sensing data or the second sensing data being determined to be normal.

Specific details according to various embodiments other than the above-mentioned challenges are included in the description and drawings below.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the disclosure, are incorporated in and constitute a part of this disclosure, illustrate aspects and embodiments of the disclosure, and together with the description serve to explain principles and examples of the disclosure. FIG. 1 is a block diagram schematically illustrating a configuration of a display apparatus, according to one example embodiment of the present disclosure.

FIG. 2 is a schematic illustration of a configuration of a sub-pixel according to one example embodiment of the present disclosure.

FIG. 3 is an equivalent circuit illustrating a sub-pixel configuration according to one example embodiment of the present disclosure.

FIG. 4 is a diagram illustrating a drive waveform of a sub-pixel, according to one example embodiment of the present disclosure.

FIG. 5 is a diagram illustrating a sensing path of a sensing sub-pixel in a display apparatus, according to one example embodiment of the present disclosure.

FIG. 6 is an illustration of a sensing area of a display apparatus, according to one example embodiment of the present disclosure.

FIGS. 7 to 9 are diagrams each illustrating a color-specific sensing path in a display apparatus, according to one example embodiment of the present disclosure.

FIG. 10 is a diagram illustrating a flow of leakage current in a display apparatus, according to one example embodiment of the present disclosure.

FIG. 11 is a graph illustrating a current-voltage change characteristic of a light emitting element due to leakage current influence, according to one example embodiment of the present disclosure.

FIG. 12 is a flowchart illustrating a method of driving a sensing mode of a display apparatus, according to one example embodiment of the present disclosure.

FIG. 13 is a graph illustrating a change in a current-voltage characteristic of a light emitting element in response to varying a sensing current, according to one example embodiment of the present disclosure.

FIG. 14 is a waveform diagram illustrating an example sensing sequence of a display apparatus, according to one example embodiment of the present disclosure.

FIGS. 15 and 16 are illustrations of a luminance change process of an image pattern that may confirm a sensing behavior in response to a sensing current variation of a display apparatus according to one example embodiment of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Reference is now made in detail to embodiments of the present disclosure, examples of which may be illustrated in the accompanying drawings. In the following description, when a detailed description of well-known methods, functions, structures or configurations may unnecessarily obscure aspects of the present disclosure, the detailed description thereof may have been omitted for brevity. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, widths, heights, thicknesses, locations, radii, diameters, and areas), proportions, ratios, angles, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., layers, films, components, sections, members, parts, regions, areas, portions, steps, operations, and/or the like), one or more other elements may be added unless a term such as “only” or the like is used. The terms used in the present disclosure are merely used in order to describe particular example embodiments, and are not intended to limit the scope of the present disclosure. The terms of a singular form may include plural forms unless the context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, size, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., layers, films, components, sections, members, parts, regions, areas, portions, and/or the like) are described using any of the terms such as “on,” “upon,” “over,” “under,” “above,” “upper,” “below,” “lower,” “beneath,” “near,” “close to,” “adjacent to,” “beside,” “next to,” “at or on a side of,” and/or the like indicating a position or location, one or more other elements may be located between the two elements unless a more limiting term, such as “immediate(ly),” “direct(ly),” or “close(ly),” is used. For example, when an element and another element are described using any of the foregoing terms, this description should be construed as including a case in which the elements contact each other directly as well as a case in which one or more additional elements are disposed or interposed therebetween. Furthermore, the spatially relative terms such as the foregoing terms as well as other terms such as “front,” “rear,” “left,” “right,” “top,” “bottom,” “upper,” “lower,” “downward,” “up,” “down,” “column,” “row,” “vertical,” “horizontal,” “diagonal,” and the like refer to an arbitrary frame of reference. For example, these terms may be used for an example understanding of a relative relationship between elements, including any correlation as shown in the drawings. However, embodiments of the disclosure are not limited thereby or thereto. The spatially relative terms are to be understood as terms including different orientations of the elements in use or in operation in addition to the orientation depicted in the drawings or described herein. For example, where a lower element or an element positioned under another element is overturned, then the element may be termed as an upper element or an element positioned above another element. Thus, for example, the term “under” or “beneath” may encompass, in meaning, the term “above” or “over.” An example term “below” or the like, can include all directions, including directions of “below,” “above” and diagonal directions. Likewise, an example term “above,” “on” or the like can include all directions, including directions of “above,” “on,” “below” and diagonal directions.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” and the like may be used herein to describe various elements (e.g., layers, films, components, sections, members, parts, regions, areas, portions, steps, operations, and/or the like), these elements should not be limited by these terms, for example, to any particular order, precedence, or number of elements. These terms are used only to distinguish one element from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

The expression that an element (e.g., layer, film, component, section, member, part, region, area, portion, or the like) “is engaged” with another element may be understood, for example, as that the element may be either directly or indirectly engaged with the another element. The term “is engaged” or similar expressions may refer to a term such as “is in contact,” “overlaps,” “crosses,” “intersects,” “is connected,” “is coupled,” “is combined,” “is linked,” “is provided,” “is disposed,” “interacts,” or the like. The engagement may involve one or more intervening elements disposed or interposed between the element and the another element, unless otherwise specified. Further, the element may be included in at least one of two or more elements that are engaged with each other. Similarly, the another element may be included in at least one of two or more elements that are engaged with each other. When the element is engaged with the another element, at least a portion of the element may be engaged with at least a portion of the another element. The term “with another element” or similar expressions may be understood as “another element,” or “with, to, in, or on another element,” as appropriate by the context. Similarly, the term “with each other” may be understood as “each other,” or “with, to, or on each other,” as appropriate by the context.

The phrase “through” may be understood, for example, to be at least partially through or entirely through.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, “at least some,” “some,” “some elements,” “a portion,” “portions,” “at least a portion,” “at least portions,” “a part,” “at least a part,” “parts,” “at least parts,” “one or more,” or the like of the plurality of elements can represent (i) one element of the plurality of elements, (ii) a part of the plurality of elements, (iii) parts of the plurality of elements, (iv) multiple elements of the plurality of elements, or (v) all of the plurality of elements. Moreover, at least a portion (or a part) of an element can represent (i) a portion (or a part) of the element, (ii) one or more portions (or parts) of the element, or (iii) the element, or all parts of the element.

The expression of a first element, a second elements “and/or” a third element should be understood as one of the first, second and third elements or as any or all combinations of the first, second and third elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element (e.g., layer, film, component, section, member, part, region, area, portion, or the like) is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

Unless otherwise defined, the terms (including technical and scientific terms) used herein have the same meaning as commonly understood by one of ordinary skill in the art to which example embodiments belong. It is further understood that terms, such as those defined in commonly used dictionaries, should be interpreted as having a meaning that is, for example, consistent with their meaning in the context of the relevant art and should not be interpreted in an idealized or overly formal sense unless expressly defined otherwise herein.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

Further, all the components of each display apparatus, display device, and display panel according to all aspects of the present disclosure are operatively coupled and configured.

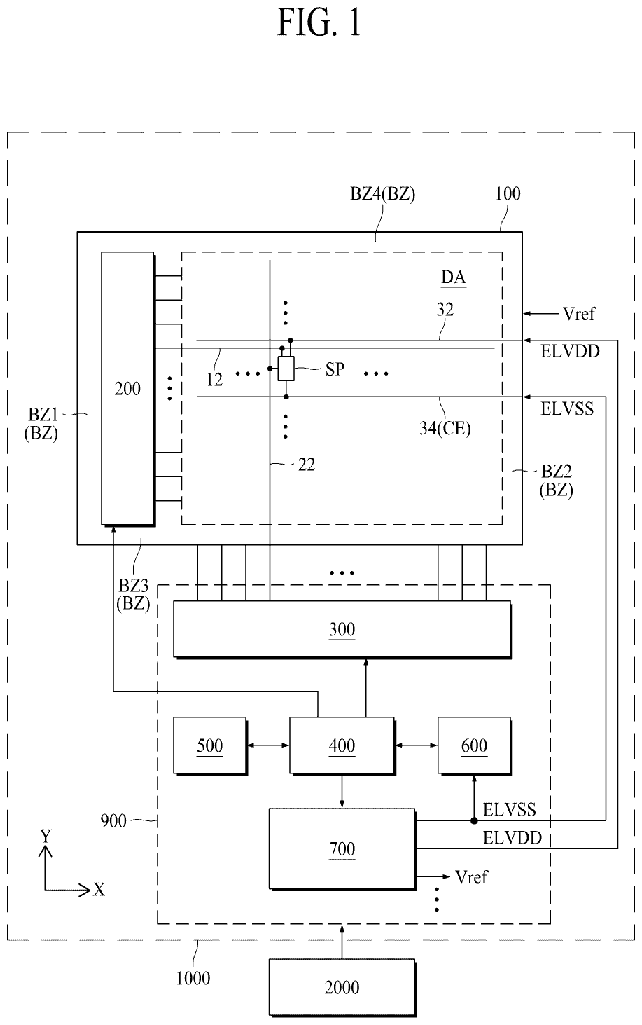

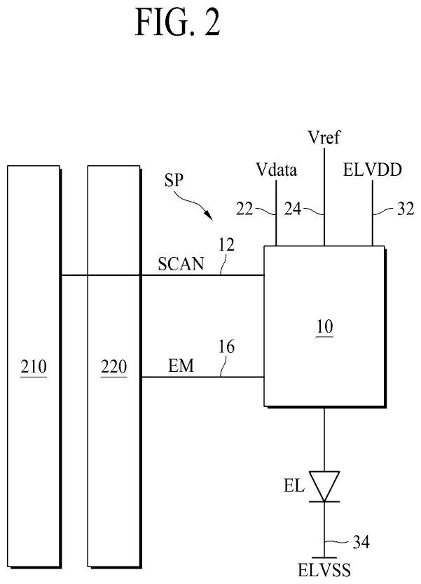

FIG. 1 is a block diagram schematically illustrating a configuration of a display apparatus according to one example embodiment of the present disclosure, and FIG. 2 is a diagram schematically illustrating a configuration of a sub-pixel according to one example embodiment of the present disclosure.

The display apparatus 1000, according to one example embodiment, may be an Electroluminescence Display, including an Organic Light Emitting Diode (OLED) display device, a Quantum-dot Light Emitting Diode display device, or an Inorganic Light Emitting Diode display device. The display apparatus 1000 according to one example embodiment may be a Micro Light Emitting Diode display device.

Referring to FIG. 1, a display apparatus 1000 may include a display panel 100, a display driver circuit 900. The display driver circuit 900 may be connected with a host system 2000.

The display driver circuit 900 may include a gate driver 200, a data driver 300, a timing controller 400, a memory 500, a sensing circuit 600, and a power management circuit 700. In the display driver circuit 900, other configurations except for the sensing circuit 600 may be represented as driver circuits.

The display panel 100 may be a rigid display panel or a flexible display panel that may be deformed, such as a foldable, bendable, rollable, or stretchable display panel.

The display panel 100 may include a display area DA that displays an image, and bezel areas BZ: BZ1 to BZ4 that surround the display area DA and are disposed on the periphery.

The display panel 100, according to one example embodiment, may further include a touch sensor array disposed in the display area DA to sense a user's touch.

The display panel 100 may display an image using a display area DA in which a plurality of sub-pixels SP are disposed in a matrix form. The pixel matrix of the display area DA may include a plurality of pixel row lines including the plurality of sub-pixels SPs disposed in a first direction X and a plurality of pixel column lines including the plurality of sub-pixels SPs disposed in a second direction Y.

The sub-pixel SP may be any one of a red sub-pixel emitting red light, a green sub-pixel emitting green light, and a blue sub-pixel emitting blue light. The sub-pixel SP may be a white sub-pixel emitting white light. The unit pixel may include at least two sub-pixels SP.

Referring to FIG. 2, the sub-pixel SP may include a light emitting element EL, and a pixel circuit 10 driving the light emitting element EL.

The sub-pixel SP according to an example embodiment may be supplied with a data voltage Vdata from the data driver 300 through at least one data line 22. The sub-pixel SP may be supplied with a scan signal SCAN through at least one gate line 12 from the gate driver 200, and may be supplied with an emission control signal EM through at least one gate line 16. The sub-pixel SP according to an example embodiment may be supplied with a high potential power voltage ELVDD through a first power line 32 from the power management circuit 700, may be supplied with a low potential power voltage ELVSS through a common electrode (cathode electrode) CE and a second power line 34, and may be supplied with a reference voltage Vref through a reference line 24.

The gate driver 200 may be disposed in the bezel area BZ of the display panel 100, or may be disposed to be distributed in the display area DA. The gate driver 200 according to one example embodiment may be embedded in a Gate In Panel (GIP) type, which is composed of transistors formed in the same process as the transistors in the display area (DA). The gate driver 200 according to one example embodiment may be disposed in any one of the first and second bezel areas BZ1, BZ2 facing each other with the display area DA interposed therebetween, or may be disposed on both of the first and second bezel areas BZ1, BZ2.

The gate driver 200 may include at least one scan driver 210 driving the at least one gate line 12, and at least one light emitting control driver 220 driving the at least one gate line 16. The number of gate lines connected to the sub-pixel SP, the number of scan drivers 210, and the number of light emitting control drivers 220 may be varied depending on the detailed configuration of the pixel circuit 10 included in the sub-pixel SP.

The gate driver 200 may be supplied with a plurality of gate control signals from the timing controller 400 to operate. In one example embodiment, the gate driver 200 may be supplied with a plurality of gate control signals from the timing controller 400 through a level shifter.

The scan driver 210 may supply at least one scan signal SCAN to at least one gate line 12 disposed on each of the plurality of pixel row lines using a plurality of first gate control signals.

The light emitting control driver 220 may supply at least one emission control signal EM to at least one gate line 16 disposed on each of the plurality of pixel row lines using a plurality of second gate control signals.

The plurality of transistors disposed in the display area DA of the display panel 100, and the bezel area BZ including the gate driver 200, may include at least one of an LTPS transistor utilizing a low temperature poly silicon (LTPS) semiconductor, and an oxide transistor utilizing a metal-oxide semiconductor. The display panel 100 according to one example embodiment may be configured to coexist with LTPS transistors and oxide transistors to reduce power consumption.

The data driver 300 may convert digital data supplied with data control signals from the timing controller 400 into analog data signals to supply data voltages Vdata to the data lines 22 of the display panel 100. The data driver 300 may include a gamma voltage generating unit, and may convert the digital data to an analog data voltage using the gamma voltages supplied from the gamma voltage generating unit.

The data driver 300 may include at least one data drive IC (integrated circuit) that drives a plurality of data lines 22 disposed on the display panel 100. Each data drive IC may be mounted on each circuit film and connected to the display panel 100. The circuit film on which the data drive ICs are mounted may be electrically connected to the display panel 100 via an anisotropic conductive film (ACF) bonded to a pad area disposed in the bezel area BZ3 of the display panel 100. The circuit film may be any one of chip on film (COF), flexible printed circuit (FPC), and flexible flat cable (FFC).

The timing controller 400 may be supplied with timing control signals and image data from the host system 2000.

The host system 2000 may be any one of a computer, a television system, a set-top box, a system on a mobile terminal such as a tablet or cell phone, or an automotive system.

The timing controller 400 may control operation of the gate driver 200 and the data driver 300 using timing control signals supplied from the host system 2000 and internally stored timing setting information. The timing controller 400 may generate gate control signals to control operation of the gate driver 200, and may generate data control signals to control operation of the data driver 300.

The timing controller 400 may perform various image processing, including image quality correction, afterimage compensation, luminance correction to reduce power consumption, and the like, using the image data supplied from the host system 2000, and may output the image data corrected by the image processing to the data driver 300.

The timing controller 400 according to one example embodiment may be supplied with sensing data that is a result of sensing electrical characteristics of the display panel 100 from the sensing circuit 600 in a sensing mode, and may predict (calculate) changes in electrical characteristics due to deterioration of the light emitting element EL based on the sensing data. When the light emitting element EL is deteriorated by driving for a long time, the current density may decrease, which may increase the impedance, and the threshold voltage. The timing controller 400 may measure (predict) an impedance change corresponding to the amount of deterioration of the light emitting element EL by calculating a threshold voltage and/or a threshold voltage shift (shift value) of the light emitting element EL based on the sensing data of the display panel 100 supplied from the sensing circuit 600.

The timing controller 400 according to one example embodiment may accumulate image data, and determine a sensing area by predicting a deterioration area having a relatively large amount of deterioration in the display panel 100 based on the accumulated data, and may sense electrical characteristics for the determined sensing area through the sensing circuit 600 to calculate a change in electrical characteristics of the light emitting element EL.

The timing controller 400, according to one example embodiment, may calculate the sensing data of each sub-pixel by scaling the sensing data for the sensing area including the plurality of sub-pixels for each sub-pixel.

The timing controller 400 according to one example embodiment may calculate an amount of change in the electrical characteristics of the light emitting element EL in the first sensing area (maximum deterioration area), that is, a threshold voltage shift, based on the difference between the sensing data in the first sensing area (maximum deterioration area) and the sensing data in the second sensing area (minimum deterioration area).

The timing controller 400 according to one example embodiment may determine whether there is an error in the sensing data, and may adjust the sensing current applied to the display panel 100 via the power management circuit 700 when determining an error in the sensing data. The timing controller 400 according to one example embodiment may compare the present sensing data with the previous sensing data to determine whether there is an error in the present sensing data. The timing controller 400 according to one example embodiment may control to repeat the sensing operation for the same sensing path of the display panel 100 using the adjusted sensing current, and may repeat the adjustment of the sensing current and the same sensing operation until the sensing data supplied via the sensing circuit 600 falls within a preset target range. A specific description of this will be described later.

The timing controller 400 according to one example embodiment may calculate a change in the sensed electrical characteristics (threshold voltage shift value) of the light emitting element EL based on the sensing data included in the target range. The timing controller 400 according to one example embodiment may calculate a compensation gain (luminance gain) to compensate for the deterioration of the light emitting element EL based on the amount of change in the electrical characteristics (threshold voltage shift value) of the light emitting element EL and store it in the memory 500.

The timing controller 400 may compensate for afterimages due to deterioration of each of the light emitting elements EL by compensating and outputting the image data using the compensation gain stored in the memory 500.

The sensing circuit 600 may sense electrical characteristics of the sensing area of the display panel 100 as a voltage through the second power line 34 in a sensing mode according to control of the timing controller 400, and may convert the sensing voltage into the sensing data and transmit it to the timing controller 400.

The sensing circuit 600, according to one example embodiment, may sense electrical characteristic of the sensing area a plurality of times and determine a median (average value) for the generated plurality of sensing data as the final sensing data and transmit it to the timing controller 400.

The sensing circuit 600 according to one example embodiment may sense electrical characteristics of the sensing area of the display panel 100 per color in the sensing mode as a voltage through the second power line 34.

The display apparatus 1000, according to one example embodiment, may apply a maximum (white) grayscale data voltage to a sensing sub-pixel to cause the light emitting element EL to emit, and may apply a minimum (black) grayscale data voltage to a non-sensing sub-pixel to cause the light emitting element EL to be non-emitting.

Since the sensing circuit 600 according to one example embodiment senses electrical characteristics of the sensing sub-pixels by utilizing the common cathode electrode CE and the second power line 34, which are shared by the sensing sub-pixels and the non-sensing sub-pixels in the display panel 100, due to influence of the leak current flowing through the non-sensing sub-pixels, the sensing accuracy of the sensing sub-pixels may be deteriorated or a sensing error may be caused.

To solve this problem, the display apparatus 1000 according to one example embodiment may minimize the leakage current influence by adjusting (varying) the sensing current applied to the display panel 100 in the sensing mode. Accordingly, the display apparatus 1000 according to one example embodiment may improve sensing accuracy for changes in electrical characteristics of the sensing sub-pixel SP and the light emitting element EL by performing a sensing operation using a sensing current that minimizes leakage current influence, which may result in minimized afterimage compensation distortion or improved afterimage compensation performance.

The sensing mode of the display apparatus 1000 according to one example embodiment may be performed at the direction of the host system 2000, may be performed by a user request via the host system 2000, or may be performed according to a sequence determined by the timing controller 400.

The power management circuit (PMIC) 700 may utilize the input voltage to generate and supply a plurality of power voltages required for operation of the display driver circuit 900. The power management circuit 700 may generate and supply the high potential power voltage ELVDD, the low potential power voltage ELVSS, and the reference voltage Vref to the display panel 100.

The power management circuit 700 according to one example embodiment may be supplied set values of the high potential power voltage ELVDD and the low potential power voltage ELVSS that vary for each of the display mode and the sensing mode from the timing controller 400. The power management circuit 700 according to one example embodiment may generate and apply the high potential power voltage ELVDD and/or the low potential power voltage ELVSS set differently in the sensing mode than in the display mode to the display panel 100.

The power management circuit 700 according to one example embodiment may receive a set value of the sensing current from the timing controller 400 to generate the sensing current in the sensing mode and apply it to the display panel 100. The power management circuit 700 according to an example embodiment may be supplied with a set value of a varied sensing current from the timing controller 400 to generate a varied sensing current in the sensing mode and apply it to the display panel 100.

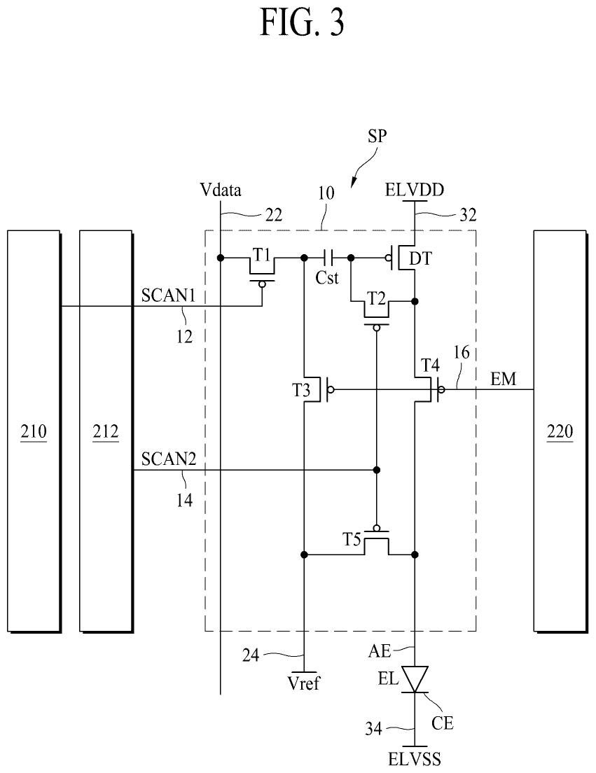

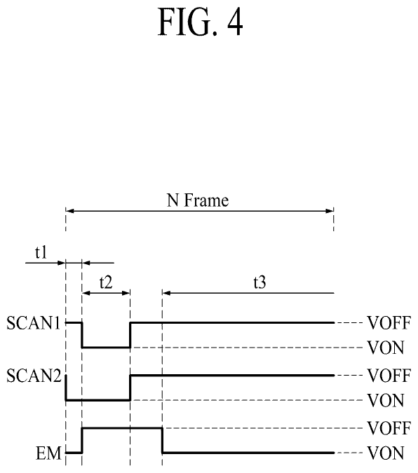

FIG. 3 is an equivalent circuit illustrating a sub-pixel configuration in a display panel according to one example embodiment of the present disclosure, and FIG. 4 is a diagram illustrating a drive waveform of a sub-pixel according to one example embodiment of the present disclosure.

Referring to FIG. 3, the sub-pixel SP may include the light emitting element EL, and the pixel circuit 10 driving the light emitting element EL. In one example embodiment, the pixel circuit 10 may include a driving transistor DT, a plurality of switching transistors T1 to T5, and a storage capacitor Cst, and is not limited to this configuration.

The pixel circuit 10 may be supplied with a first scan signal SCAN1 through a first gate line 12 from a first scan driver 210, and a second scan signal SCAN2 through a second gate line 14 from a second scan driver 212.

The pixel circuit 10 may be supplied with the emission control signal EM from the first light emitting control driver 220 through the third gate line 16.

The pixel circuit 10 may be supplied with the data voltage Vdata from the data driver 300 (FIG. 1) through the data line 22. The pixel circuit 10 may be supplied with the high potential power voltage ELVDD through the first power line 32 from the power management circuit 700 (FIG. 1), the low potential power voltage ELVSS through the second power line 34 and the common electrode CE, and the reference voltage Vref through the reference line 24.

Referring to FIG. 3, the sub-pixels SP may be driven to include an Initial period (t1), a Sampling and Writing period (t2), and an Light-emitting period (t3) for each frame period (N).

Each of the driving transistor DT and the plurality of switching transistors T1 to T5 of the pixel circuit 10 includes a gate electrode, a source electrode, and a drain electrode. Since the source electrode and the drain electrode are not fixed and may be changed according to the direction of the voltage and current applied to the gate electrode, one of the source electrode and the drain electrode may be represented as a first electrode and the other as a second electrode. The driving transistor DT and the plurality of switching transistors T1 to T5 of the pixel circuit 10 may utilize at least one of a polysilicon semiconductor, an amorphous silicon semiconductor, and an oxide semiconductor, and may be P-type or N-type, or may be a mixture of P-type and N-type.

The light emitting element EL may comprise an anode electrode AE connected with a fourth switching transistor T4, a cathode electrode CE connected with the second power line 34 supplying the low potential power voltage ELVSS, and a light emitting element layer between the anode electrode AE and the cathode electrode CE. When the light emitting element EL is supplied with a driving current from the driving transistor DT through the fourth switching transistor T4, electrons from the cathode electrode CE are injected into the light emitting element layer, and holes from the anode electrode AE are injected into the light emitting element layer, and a fluorescent or phosphorescent material emits by recombination of electrons and holes in the light emitting element layer, thus the light emitting element EL may emit light of a brightness proportional to a current value of the driving current.

The gate electrode of the driving transistor DT may be connected to the storage capacitor Cst, the first electrode may be connected to the first power line 32 supplying the high potential power voltage ELVDD, and the second electrode may be connected to the first electrode of the fourth switching transistor T4. The driving transistor DT may be connected to the light emitting element EL through the fourth switching transistor T4, and may drive the light emitting element EL through the fourth switching transistor T4. The driving transistor DT may control the emission intensity of the light emitting element EL through the fourth switching transistor T4 by controlling the driving current according to the driving voltage charged on the storage capacitor Cst.

The storage capacitor Cst may connect between the second electrode of the first switching transistor T1 and the gate electrode of the driving transistor DT to charge the driving voltage corresponding to the data voltage Vdata. The storage capacitor Cst may hold the charged driving voltage during the light-emitting period t3 in which the first switching transistor T1 is turned off, and supply it to the driving transistor DT.

The first switching transistor T1 may be turned on or turned off in response to the first scan signal SCAN1 on the first gate line 12 disposed on the i-th (i is a natural number) pixel row line. The first switching transistor T1 may supply the data voltage Vdata supplied through the data line 22 to the first electrode of the storage capacitor Cst during the sampling and writing period t2 in which the first scan signal SCAN1 has a gate-on voltage VON. The switching transistor T1 may be turned off during the initial period t1 and the light-emitting period t3 in which the first scan signal SCAN1 has a gate-off voltage VOFF.

The second and fifth switching transistors T2, T5 may be turned on or turned off in response to the second scan signal SCAN2 supplied to the second gate line 14 of the i-th pixel row line. The second and fifth switching transistors T2, T5 may be turned on during the initial period t1 and the sampling and writing period t2 in which the second scan signal SCAN2 has a gate-on voltage VON, and may be turned off during the light-emitting period t3 in which the second scan signal SCAN2 has a gate-off voltage VOFF.

The second switching transistor T2 may connect the driving transistor DT into a diode structure by connecting the gate electrode and the second electrode of the driving transistor DT in response to the second scan signal SCAN2 during the initial period t1 and the sampling and writing period t2. The second switching transistor T2 may compensate the threshold voltage Vth of the driving transistor DT by charging the threshold voltage Vth of the driving transistor DT to the storage capacitor Cst. Accordingly, the storage capacitor Cst may charge the data voltage at which the threshold voltage Vth of the driving transistor DT is compensated.

The fifth switching transistor T5 may, in response to the second scan signal SCAN2, supply a reference voltage Vref supplied through the reference line 24 to the anode electrode AE of the light emitting element EL during the initial period t1 and the sampling and writing period t2.

The third and fourth switching transistors T3, T4 may be turned on or turned off in response to the emission control signal EM supplied to the third gate line 16 of the i-th pixel row line. The third and fourth switching transistors T3, T4 may be turned on during the initial period t1 and the light-emitting period t3 in which the emission control signal EM has a gate-on voltage VON, and may be turned off during the sampling and writing period t2 and a period between the sampling and writing period t2 and the light-emitting period t3, in which the emission control signal EM has a gate-off voltage VOFF.

The third switching transistor T3 may supply the reference voltage Vref supplied through the reference line 24 to the first electrode of the storage capacitor Cst during the initial period t1 and the light-emitting period t3 in response to the light emission control signal EM.

The fourth switching transistor T4 may connect the driving transistor DT to the light emitting element EL during the initial period t1 and the light-emitting period t3 in response to the emission control signal EM.

During the light-emitting period t3 of each frame N, the driving transistor DT may drive the light emitting element EL through the fourth switching transistor T4.

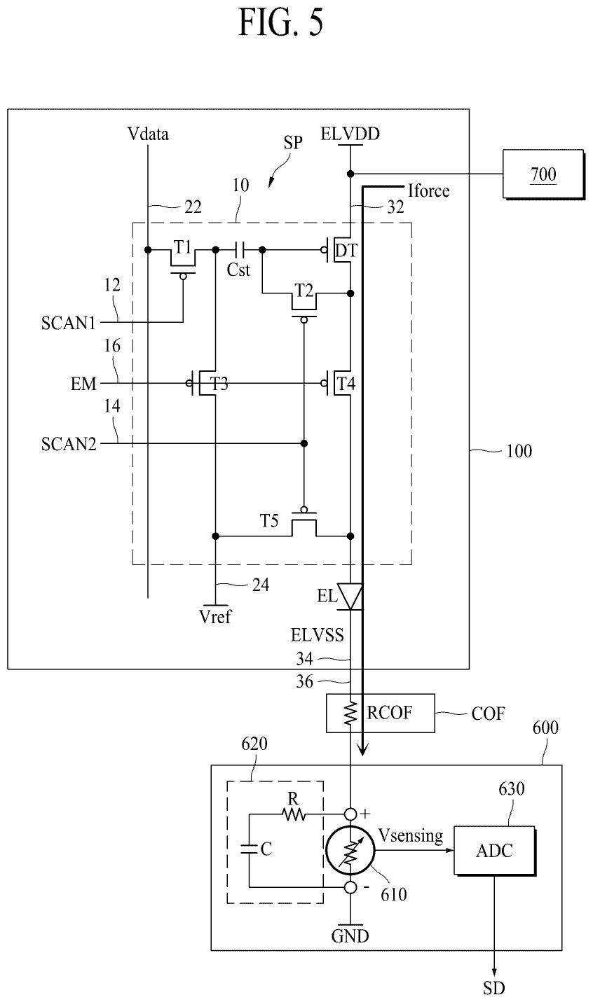

FIG. 5 is a diagram illustrating a sensing path of a sensing sub-pixel in a display apparatus, according to one example embodiment of the present disclosure.

Referring to FIG. 5, the power management circuit 700 may generate and apply the high potential power voltage EVDD, the low potential power voltage ELVSS, and the reference voltage Vref, for the sensing mode to the display panel 100, and may apply a sensing current Iforce, which is a constant current, through the first power line 32.

The second power line 34 of the display panel 100 may be connected to the sensing circuit 600 through a second power supply line 36 passing through the circuit film COF. The second power supply line 36 may be connected to the power management circuit 700 to supply the low potential power voltage ELVSS to the display panel 100.

The sensing circuit 600 according to one example embodiment may sense a voltage Vsensing reflecting the electrical characteristics of the sensing sub-pixel SP by detecting a voltage at the end of the second power line 32 using the sensing current Iforce flowing through the sensing path of the sensing sub-pixel SP of the display panel 100, and may convert the sensing voltage Vsensing into the sensing data SD and transmit it to the timing controller 400.

The sensing circuit 600, according to one example embodiment, may include a voltage sensing circuit 610, a low pass filter (LPF) 620, and an analog-to-digital converter (ADC) 630.

The voltage sensing circuit 610 may detect a voltage between the second power line 34 and the ground GND of the display panel 100 using the sensing current Iforce and output it as the sensing voltage Vsensing. In one example embodiment, the voltage sensing circuit 610 may include a current regulator, a level up/down circuit, a switching element, and the like.

The low pass filter 620 may include a resistor R and a capacitor C to block high frequency noise.

The ADC 630 may digitally convert the sensing voltage Vsensing to the sensing data SD and output it to the timing controller 400.

Referring to FIG. 5, the sub-pixels SP of which the electrical characteristics is sensed in the display panel 100 may be driven using the same drive waveform as the N frames shown in FIG. 4.

Referring to FIGS. 4 and 5, the sensing sub-pixel SP is supplied with the data voltage Vdata of a white grayscale in the sampling and writing period t2 to charge a driving voltage to the storage capacitor Cst, and during the light-emitting period t3, the driving transistor DT may have the light emitting element EL emit through the fourth switching transistor T4.

During the light-emitting period t3, the sensing current Iforce may flow through the sensing path, which connects from the first power line 32 through the driving transistor DT of the sensing sub-pixel SP, the fourth switching transistor T4, the light emitting element EL, and to the second power line 34 in the display panel 100, and passes through the second power supply line 36 including the circuit film COF or the like, to the sensing circuit 600.

By sensing the voltage between the second power line 32 and the ground GND using the sensing current Iforce, the sensing circuit 600 may sense the electrical characteristics of the sensing sub-pixel SP reflecting the threshold voltage of the light emitting element EL as the sensing voltage Vsensing and convert the sensing voltage into sensing data SD.

The sensing voltage Vsensing in the sensing circuit 600 may be a voltage reflecting components of electrical characteristics such as a threshold voltage of the driving transistor DT, a threshold voltage of the fourth switching transistor T4, a threshold voltage of the light emitting element EL, and a voltage dropped by a wiring resistance RCOF of a circuit film (COF), etc, which are included in the sensing path. For example, the sensing voltage Vsensing may be a voltage reflected by adding or subtracting voltage components of the sensing path to or from the first power supply voltage ELVDD.

The timing controller 400 (FIG. 1) according to one example embodiment may calculate a threshold voltage shift value based on the deterioration of the light emitting element EL of the first sub-pixel SP by calculating a difference between the first sensing data of the first sub-pixel SP sensed in the maximum deterioration area and the second sensing data of the second sub-pixel SP sensed in the minimum deterioration area. Based on the threshold voltage shift value, the timing controller 400 according to one example embodiment may calculate a compensation gain to compensate for the deterioration of the light emitting element EL1 and store it in the memory 500.

The display apparatus 1000 according to one example embodiment may improve sensing accuracy of changes in electrical characteristics of the sensing sub-pixel SP and the light emitting element EL by adjusting (varying) the sensing current Iforce applied to the display panel 100 in the sensing mode, to perform a sensing operation using the sensing current Iforce that minimizes leakage current effects, resulting in minimized afterimage compensation distortion or improved afterimage compensation performance.

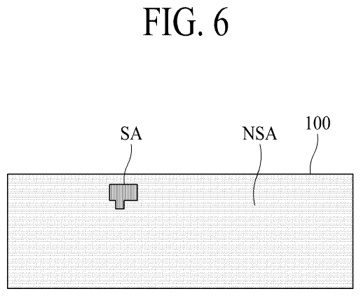

FIG. 6 is an illustration of a sensing area of a display apparatus, according to one example embodiment of the present disclosure.

Referring to FIGS. 1 and 6, the timing controller 400 of the display apparatus 1000 according to one example embodiment may determine at least one sensing area SA that is predicted to be a maximum deterioration area in the display panel 100 using the cumulative results of the image data. The at least one sensing area SA may include the plurality of sub-pixels having a similar amount of deterioration.

The display apparatus 1000 according to one example embodiment may sense electrical characteristics of the sensing area SA in the sensing mode after the sensing area SA of the display panel 100 emit light using a data voltage having a white grayscale (maximum grayscale, maximum luminance), and the non-sensing area NSA may not emit light using a data voltage having a black grayscale (minimum grayscale, minimum luminance).

The display apparatus 1000 according to one example embodiment may divide the sensing area SA by the color of the sub-pixel, and sequentially sense the color-divided sensing area SA of the display panel 100.

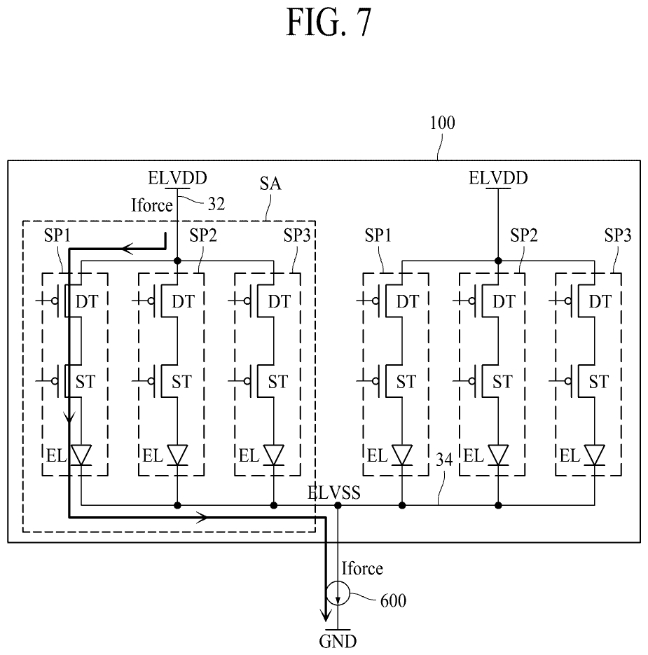

FIGS. 7 to 9 are diagrams illustrating a color-specific sensing path in a display apparatus, according to one example embodiment of the present disclosure.

Referring to FIGS. 7 to 9, the display apparatus according to one example embodiment may sense a first color sub-pixels SP1 in a first sensing period, sense a second color sub-pixels SP2 in a second sensing period, and sense a third color sub-pixels SP3 in a third sensing period, among the sensing areas SA of the display panel 100.

Referring to FIG. 7, the display apparatus according to one example embodiment may cause the light emitting elements EL of the first sensing sub-pixels SP1 to emit in a white grayscale (luminance) among the sensing areas SA of the display panel 100, and the non-sensing sub-pixels SP2, SP3 of the sensing area SA and the sub-pixels SP1, SP2, SP3 of the non-sensing area to be non-emitting in a black grayscale (luminance). The sensing circuit 600 may sense the electrical characteristics of the first sensing sub-pixels SP1 reflecting the threshold voltage of the light emitting element EL of the first sensing sub-pixels SP1 by sensing the voltage at the end of the second power line 34 using the sensing current Iforce flowing from the first power line 32 through the first sensing path passing through the light emitting element EL of the first sensing sub-pixels SP1 to the second power line 34.

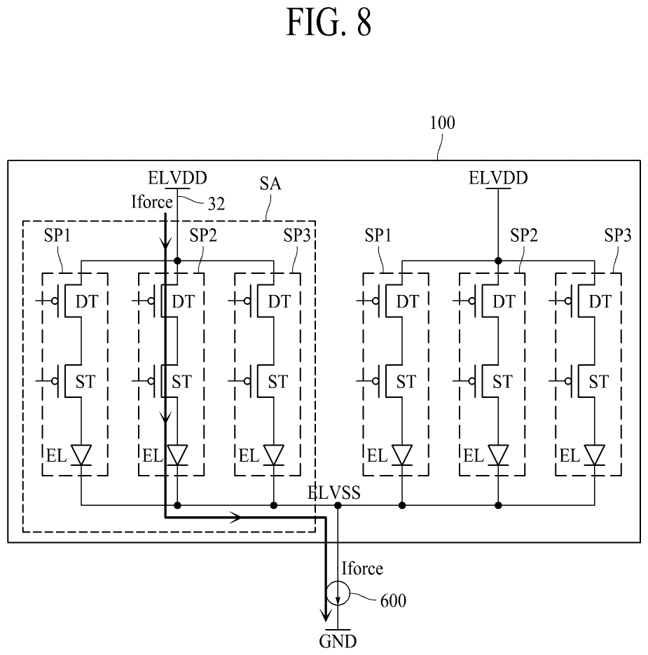

Referring to FIG. 8, the display apparatus according to one example embodiment may cause the light emitting elements EL of the second sensing sub-pixels SP2 to emit in a white grayscale among the sensing areas SA of the display panel 100, and the non-sensing sub-pixels SP1, SP3 of the sensing area SA and the sub-pixels SP1, SP2, SP3 of the non-sensing area to be non-emitting in a black grayscale. The sensing circuit 600 may sense the electrical characteristics of the second sensing sub-pixels SP2 reflecting the threshold voltage of the light emitting element EL of the second sensing sub-pixels SP2 by sensing the voltage at the end of the second power line 34 using the sensing current Iforce flowing from the first power line 32 to the second power line 34 through a second sensing path passing through the light emitting element EL of the second sensing sub-pixels SP2.

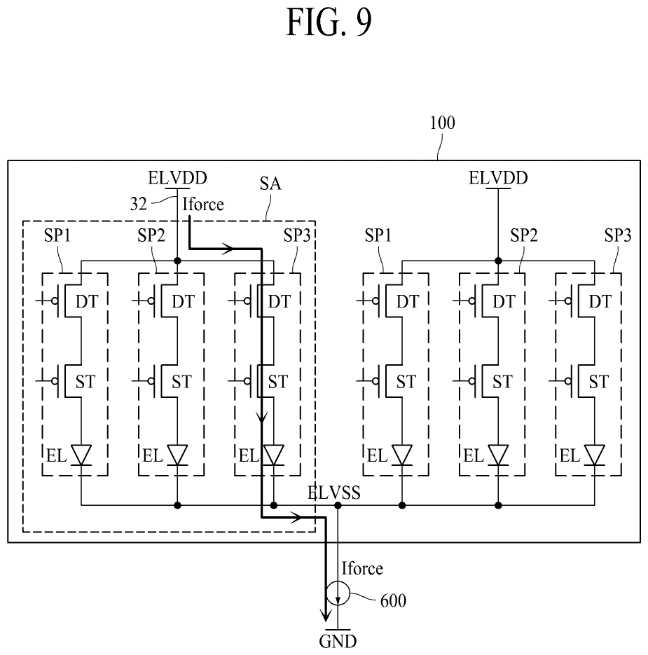

Referring to FIG. 9, the display apparatus according to one example embodiment may cause the light emitting elements ELs of the third sensing sub-pixels SP3 to emit in a white grayscale among the sensing areas SA of the display panel 100, and the non-sensing sub-pixels SP1, SP2 of the sensing area SA and the sub-pixels SP1, SP2, SP3 of the non-sensing area to be non-emitting in a black grayscale. The sensing circuit 600 may sense the electrical characteristics of the third sensing sub-pixels SP3 reflecting the threshold voltage of the light emitting element EL of the third sensing sub-pixels SP3 by sensing the voltage at the end of the second power line 34 using the sensing current Iforce flowing from the first power line 32 to the second power line 34 through a third sensing path passing through the light emitting element EL of the third sensing sub-pixels SP3.

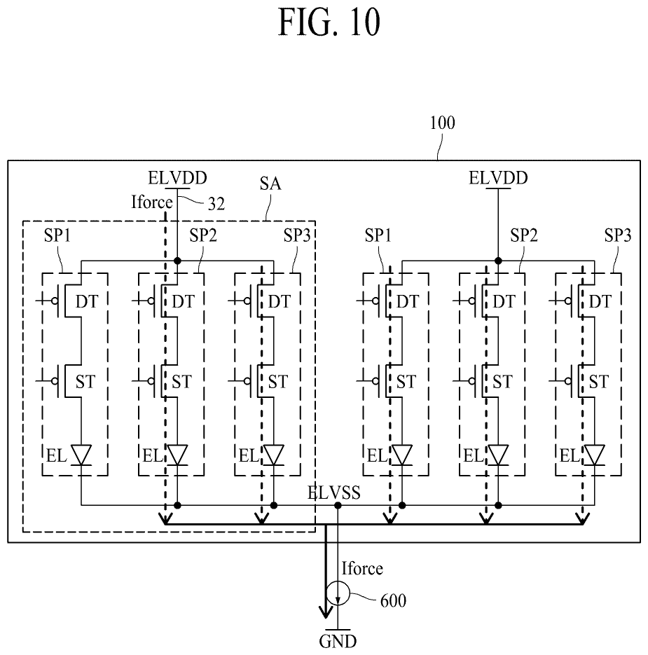

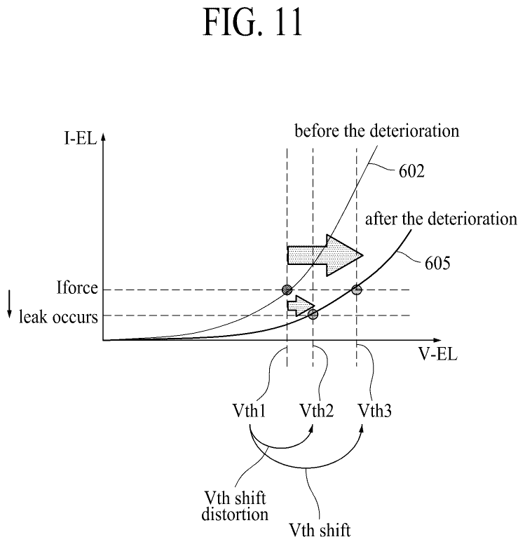

FIG. 10 is a diagram illustrating a flow of a leakage current in a sensing operation of a display apparatus according to one example embodiment of the present disclosure, and FIG. 11 is a graph illustrating a current-voltage change characteristic of an light emitting element due to leakage current influence in a display apparatus according to one example embodiment of the present disclosure.

Referring to FIG. 10, in one example embodiment, when causing the sensing sub-pixels SP1 among the sensing area of the display panel 100 to emit and sensing electrical characteristics of the sensing sub-pixels SP1 among the sensing area of the display panel 100, leakage current may occur in the non-sensing sub-pixels SP2, SP3 of the sensing area SA and the non-sensing sub-pixels SP1, SP2, SP3 of the non-sensing area, which are displaying black. In this case, the sensing current Iforce that should flow only through the sensing path of the sensing sub-pixel SP1 may be distributed to the non-sensing sub-pixels SP2, SP3 of the sensing area SA, the non-sensing sub-pixels SP1, SP2, SP3 of the non-sensing area, causing the low potential power voltage ELVSS of the second power line 34 to increase. Accordingly, a sensing distortion may occur in which the sensing data sensed through the sensing circuit 600 is reduced from the sensing data sensed in the previous sensing mode. As the threshold voltage Vth increases when the light emitting element EL deteriorates, it is normal for the present sensing data to increase than the previous sensing data, and the present sensing data decreasing than the previous sensing data may be determined to be a distortion due to leakage current effects.

Referring to FIG. 11, when the light emitting element EL deteriorates, it shifts (increases) from a threshold voltage Vth1 in the current (I-EL)-voltage (V-EL) characteristic 602 before the light emitting element EL deteriorates to a threshold voltage Vth2 in the current (I-EL)-voltage (V-EL) characteristic 605 after the light emitting element EL deteriorates. Thus, the display apparatus according to one example embodiment may compensate for the afterimage by calculating (predicting) the threshold voltage shift value Vth shift from the sensing data of the sensing circuit 600 through a sensing operation of the light emitting element EL using the sensing current Iforce. In the sensing operation, when a leakage current occurs, an error may occur in the sensing data, and the threshold voltage Vth3 and the threshold voltage shift value Vth shift of the light emitting element EL calculated therefrom may be distorted, thereby distorting the afterimage compensation.

To solve this problem, the display apparatus according to one example embodiment may perform a sensing operation using the sensing current Iforce that minimizes a leakage current influence by adjusting (varying) the sensing current Iforce applied to the display panel 100, thereby improving a sensing accuracy for a threshold voltage Vth and/or a threshold voltage shift value Vth shift of the light emitting element EL, which may result in minimized afterimage compensation distortion or improved afterimage compensation performance.

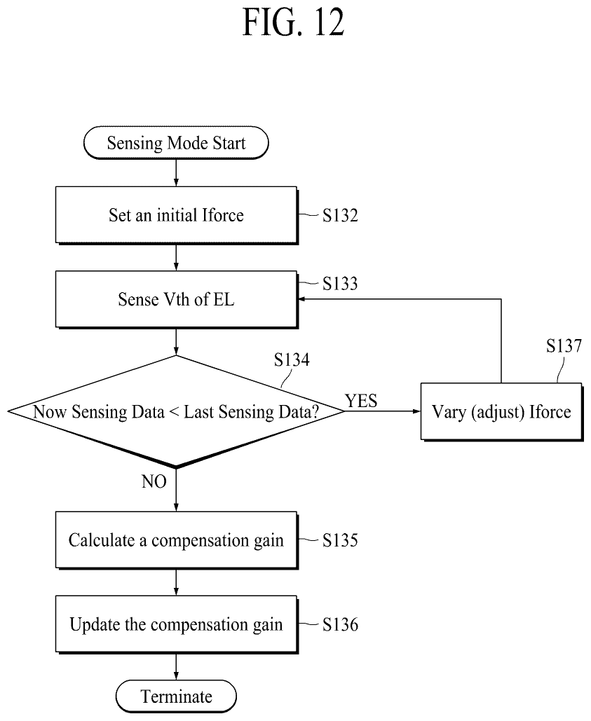

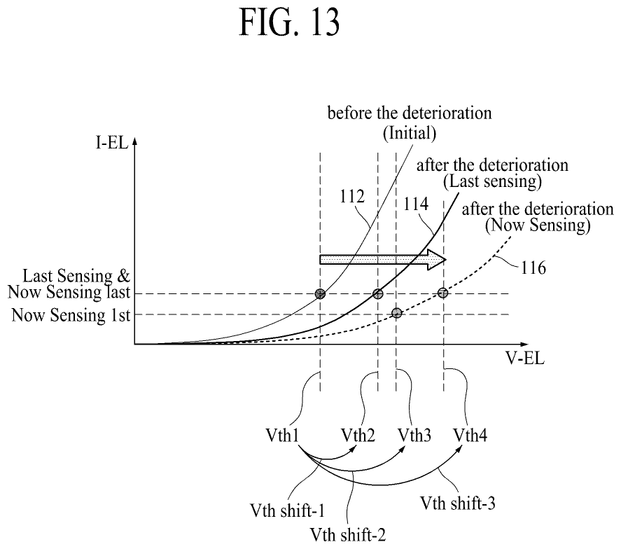

FIG. 12 is a flowchart illustrating a method of driving a sensing mode of a display apparatus according to one example embodiment of the present disclosure, and FIG. 13 is a graph illustrating a change in a current-voltage characteristic of an light emitting element in response to a change in a sensing current according to one example embodiment of the present disclosure.

Referring to FIG. 12, the display apparatus according to one example embodiment may initiate a sensing mode and set an initial sensing current Iforce S132.

The display apparatus according to one example embodiment may perform a first sensing sequence of sensing electrical characteristics of at least one sensing area displaying a particular image pattern on the display panel using the sensing current Iforce and generating sensing data S133. The sensing data may include threshold voltages Vth of light emitting elements EL of the sensing sub-pixels.

The display apparatus according to one example embodiment may compare the present sensing data (Now Sensing Data) of the sensing area with the last sensing data (Last Sensing Data) measured in a previous sensing mode to determine whether the present sensing data (Now Sensing Data) is distorted by the effect of the leakage current S134. The Now Sensing Data may be a median or average value of the current sensing data for the plurality of sensing areas of the present (nth) sensing mode. The Last Sensing Data may be a median or average value of the previous sensing data for the plurality of sensing areas of the previous (last, n−1st) sensing mode.

The display apparatus according to one example embodiment may determine that the present sensing data (Now Sensing Data) is distorted due to the influence of the leakage current when the present sensing data (Now Sensing Data) is smaller than the last sensing data (Last Sensing Data) S134, YES, and may vary (adjust) the sensing current Iforce S137. The display apparatus according to one example embodiment may increase the sensing current Iforce according to a preset set value. The display apparatus according to one example embodiment may search for the sensing current Iforce using a binary search method to determine a current value, and may increase the sensing current Iforce to the determined current value.

The display apparatus according to one example embodiment may apply the regulated sensing current Iforce to the display panel, and repeat a second sensing sequence of displaying a specific image pattern in the sensing area and sensing the sensing area, as same as the first sensing sequence, so that the present sensing data (Now Sensing Data) may be compared with the last sensing data (Last Sensing Data) S133, S134. In the display apparatus according to one example embodiment, as the current value of the sensing current Iforce increases, the brightness of a particular image pattern displayed in the sensing area may increase.

In the display apparatus according to one example embodiment, when the present sensing data (Now Sensing Data) is smaller than the last sensing data (Last Sensing Data) (S134, YES), the variable (adjust) sensing current Iforce step S137 and the same sensing sequence steps S133, S134 may be repeated.

The display apparatus according to one example embodiment may repeat the variable (adjust) sensing current Iforce step S137 and the same sensing sequence steps S133, S134 until the Now Sensing Data enters a target range where the Now Sensing Data is greater than the Last Sensing Data.

The display apparatus according to one example embodiment may, when the present sensing data (Now Sensing Data) enters a target range that is greater than the last sensing data (Last Sensing Data) (S134, No), determine the present sensing data as normal data, calculate a threshold voltage shift value of the light emitting element EL based on the present sensing data, and calculate a compensation gain S135. The display apparatus according to one example embodiment may store the calculated compensation gain in a memory to update the compensation gain S136, and may terminate the sensing mode.

Referring to FIG. 13, as the light emitting element EL deteriorates, it shifts from a threshold voltage Vth1 in the current (I-EL)-voltage (V-EL) characteristic 112 before the light emitting element EL deteriorates, to a threshold voltage Vth2 in the current (I-EL)-voltage (V-EL) characteristic 114 after the light emitting element EL deteriorates, and to a threshold voltage Vth4 in the current (I-EL)-voltage (V-EL) characteristic 116 after the light emitting element EL deteriorates.

The display apparatus according to one example embodiment may sense the threshold voltage Vth2 of the light emitting element EL through the last sensing mode operation (last Sensing) using the sensing current Iforce and calculate (predict) the threshold voltage shift value Vth shift-1 to compensate for the afterimage.

The display apparatus according to one example embodiment may sense a threshold voltage Vth3 or a threshold voltage shift value Vth shift-2 of the light emitting element EL through a first sensing operation (Now Sensing 1st) of the present sensing mode using the sensing current Iforce. The display apparatus according to one example embodiment may adjust the sensing current Iforce when a sensing error occurs such that the present sensing data is smaller than the previous sensing data due to the influence of the leakage current, and sense the threshold voltage Vth4 of the light emitting element EL through the second sensing operation (Now Sensing last) of the present sensing mode.

The display apparatus according to one example embodiment may determine that the sensing data of the second sensing operation of the present sensing mode is larger than the previous sensing data and is normal data included in the target range, and may calculate (predict) a threshold voltage shift value Vth shift-3 of the light emitting element (EL) from the present sensing data to compensate for the afterimage.

The display apparatus according to one example embodiment may determine the current value of the sensing current Iforce using a binary search method.

The binary search method for the sensing current Iforce of the display apparatus according to one example embodiment may repeatedly perform the operation of comparing a median value of the present sensing data with a target value to reduce a range of search current values by ½, repeating the operation until the number of current values in the search range is 1, and reducing the number of search current values by ½ in a single search.

In one example embodiment, the display apparatus may set the current value that is most similar to the average value of the last sensing data of the previous sensing mode as the target value. The display apparatus according to one example embodiment may perform the sensing operation every constant deterioration period, thus the meaning of constant deterioration may mean that the average value of the previous sensing data and the average value of the present sensing data are the same. The display apparatus according to one example embodiment may find a condition (target value) in which the average value of the sensing data is similar or equal, and then calculate a deterioration characteristic for each sensing area of the display panel based on the data sensed under the condition to compensate for the afterimage.

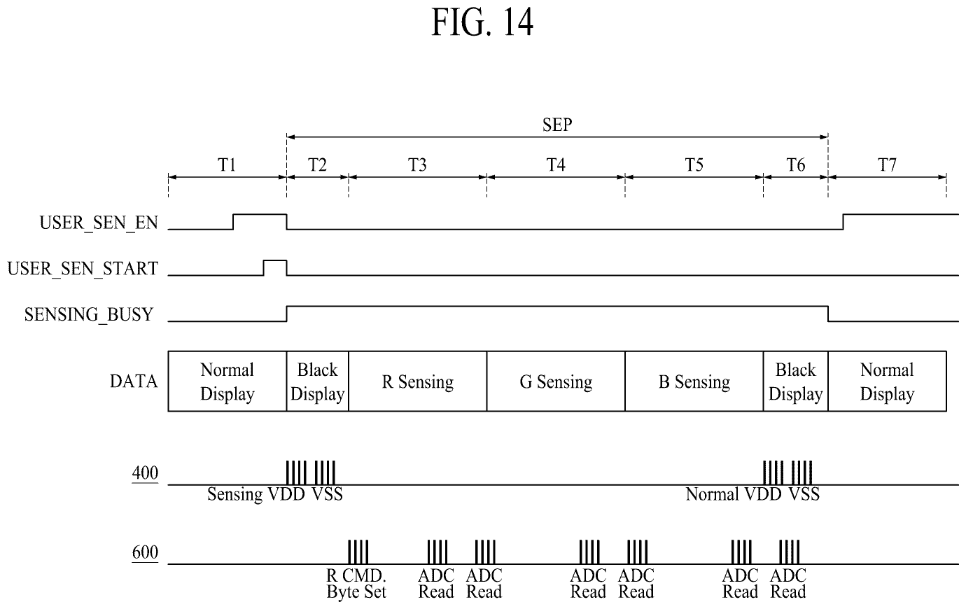

FIG. 14 is a waveform diagram illustrating an example sensing sequence of a display apparatus, according to one example embodiment of the present disclosure.

Referring to FIGS. 1 and 14, the display apparatus 1000 according to one example embodiment may operate in a sensing mode in response to a sensing enable signal SEN_EN and a sensing start signal SEN_START transmitted at a first time T1 from the host system 2000, and the timing controller 400 may transmit a sensing status signal SEN_BUSY representing of an operating period SEP of the sensing mode to the host system 2000.

The display apparatus 1000 according to one example embodiment may divide the operating period SEP of the sensing mode into first to third sensing periods (R Sensing, G Sensing, B Sensing) T3, T4, T5 divided by each of R, G, and B colors. In each of the first to third sensing periods T3, T4, T5, the display apparatus 1000 according to an example embodiment may display the maximum grayscale image pattern of each color in the sensing area of the display panel 100 to sense the sensing area SA, and may display black grayscale in the non-sensing area.

In each of the first to third sensing periods (R Sensing, G Sensing, B Sensing) T3, T4, T5 for each color, the display apparatus 1000 according to one example embodiment may repeat the sensing operation for the at least one sensing area by varying the sensing current Iforce until the sensing data enters the target range, and the sensing circuit 600 may transmit the plurality of sensing data to the timing controller 400.

The display apparatus 1000 according to one example embodiment may display black grayscale data on the display panel 100 in each of the second period T2 before the first sensing period T3, and the sixth period T6 after the third sensing period T5, of the operating period SEP of the sensing mode.

In the display apparatus 1000 according to one example embodiment, the timing controller 400 may supply a set value of the high potential power voltage Sensing VDD, VSS for the sensing mode to the power management circuit 700 during the second period T2 when the display panel 100 displays black grayscale. The power management circuit 700 may generate and apply the high potential power voltage ELVDD, ELVSS for the sensing mode to the display panel 100 during the sensing periods T3, T4, and T5. The timing controller 400 may supply a set value of the high potential power voltage Normal VDD, VSS for the display mode to the power management circuit 700 during the sixth period T6 when the display panel 100 displays a black grayscale. The power management circuit 700 may generate and apply the high potential power voltage ELVDD, ELVSS for the display mode to the display panel 100 during the display mode operating period T7 after the sensing period SEP.

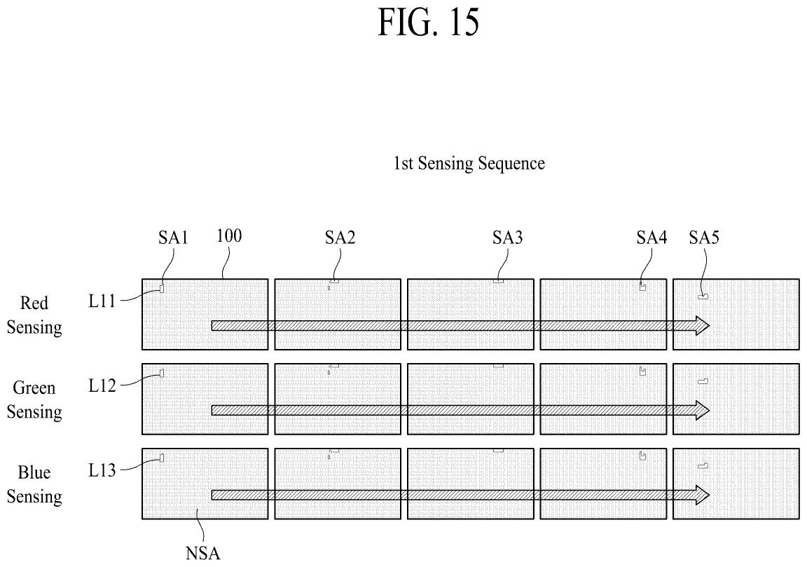

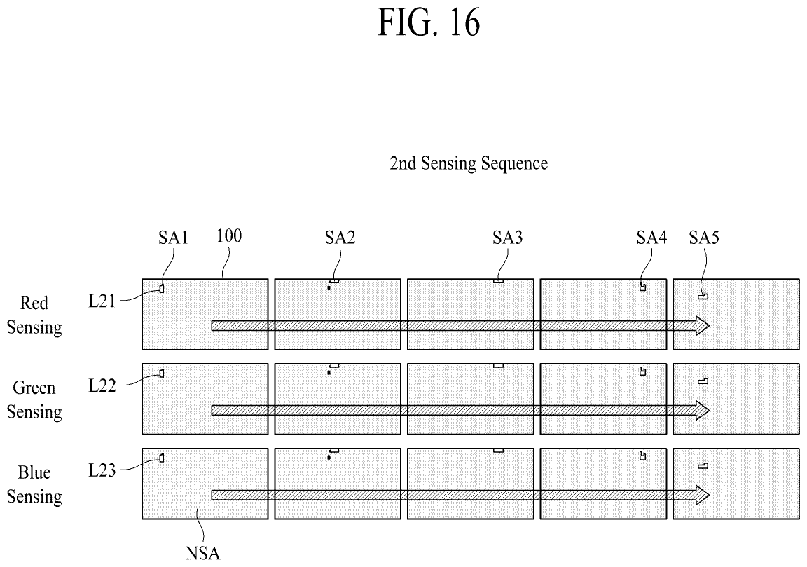

FIGS. 15 and 16 are illustrations of a luminance change process of an image pattern that may confirm a sensing behavior in response to a sensing current variation of a display apparatus according to one example embodiment of the present disclosure.

Referring to FIG. 15, the display apparatus according to one example embodiment may perform the operation of sensing the first to fifth sensing areas SA1 to SA5 for each area and for each color using a first sensing current according to the first sensing sequence of the sensing mode.

The display apparatus according to one example embodiment may, in a first sensing period of the first sensing area SA1 of the display panel 100, display a maximum gradient image pattern on the red sub-pixels that are sensing sub-pixels of the first sensing area SA1, display a minimum gradient image on the sub-pixels of the first sensing area SA1 and the non-sensing area NSA, and sense the electrical characteristics of the sensing (red) sub-pixels of the first sensing area SA1 using a first sensing current. Here, the first sensing area SA1 may display a red image pattern of the 1-1 brightness L11.

The display apparatus according to one example embodiment may, in the second sensing period of the first sensing area SA1 of the display panel 100, display a maximum gradient image pattern on the green sub-pixels that are sensing sub-pixels of the first sensing area SA1, display a minimum gradient image on the sub-pixels of the first sensing area SA1 and the non-sensing area NSA, and sense electrical characteristics of the sensing (green) sub-pixels of the first sensing area SA1 using the first sensing current. Here, the first sensing area SA1 may display a green image pattern of the 1-2 brightness L12.

The display apparatus according to an example embodiment may, in the second sensing period of the first sensing area SA1 of the display panel 100, display a maximum gradient image pattern on the blue sub-pixels that are sensing sub-pixels of the first sensing area SA1, display a minimum gradient image on the sub-pixels of the first sensing area SA1 and the non-sensing area NSA, and sense electrical characteristics of the sensing (blue) sub-pixels of the first sensing area SA1 using the first sensing current. Here, the first sensing area SA1 may display a blue image pattern of the 1-3 brightness L13.

The display apparatus according to one example embodiment may sequentially sense each of the second to fifth sensing areas SA2 to SA5 of the display panel 100, for each color, using the same first sensing current as the first sensing area SA1.

The display apparatus according to one example embodiment may sequentially display a red image pattern of the 1-1 brightness L11, a green image pattern of the 1-2 brightness L12, and a blue image pattern of the 1-3 brightness L13 in each of the first to fifth sensing areas SA1 to SA5, which are sequentially sensed according to the first sensing sequence.

The display apparatus according to one example embodiment may vary the sensing current and repeat the sensing operation according to the second sensing sequence identical to the first sensing sequence as shown in FIG. 16 when the sensing data obtained through the first sensing sequence is determined to be a sensing error compared to the sensing data of the previous sensing mode.

Referring to FIG. 16, the display apparatus according to one example embodiment may sense the first to fifth sensing areas SA1 to SA5 for each area and for each color using a second sensing current that is increased from the first sensing current, according to a second sensing sequence of the sensing mode.

The display apparatus according to one example embodiment may sequentially display a red image pattern of the 2-1 brightness L21, a green image pattern of the 2-2 brightness L22, and a blue image pattern of the 2-3 brightness L23 in each of the first to fifth sensing areas SA1 to SA5, which are sequentially sensed according to the second sensing sequence.

The display apparatus according to one example embodiment may utilize the second sensing current in the second sensing sequence that is increased from the first sensing current utilized in the first sensing sequence. Accordingly, in the second sensing sequence, the brightness of each of the red image pattern of the 2-1 brightness L21, the green image pattern of the 2-2 brightness L22, and the blue image pattern of the 2-3 brightness L23 displayed for each color in the sensing areas SA1 to SA5 may be increased more than the brightness of each of the red image pattern of the 1-1 brightness L11, the green image pattern of the 1-2 brightness L12, and the blue image pattern of the 1-3 brightness L13 displayed for each color in the sensing areas SA1 to SA5 in the first sensing sequence.

As such, whether or not a sensing operation is applied based on varying the sensing current of the display apparatus according to one example embodiment may be verified by confirming that the brightness of the image pattern displayed in the at least one sensing area of the display panel is progressively increased by the increase in the sensing current as the same sensing sequence is repeated.

A display apparatus according to some aspects may include a display panel including a plurality of sub-pixels, a driver circuit configured to drive the display panel, and a sensing circuit for sensing electrical characteristics of a sensing area of display panel to output sensing data, wherein the driver circuit may perform a sequence that varies sensing current applied to a first power line until the sensing data falls within a target range in a sensing mode, and may repeat the sequence with respect to the sensing area.

In the display apparatus according to some aspects, the driver circuit may apply a first sensing current to the display panel in a first sensing sequence of the sensing mode and may apply a second sensing current increased more than the first sensing current to the display panel in a second sensing sequence of the sensing mode.

In the display apparatus according to some aspects, the driver circuit may provide a same grayscale of image patterns in the first sensing sequence and the second sensing sequence to the sensing area, wherein the sensing area may display the image pattern at a first brightness in the first sensing sequence and may display the image pattern at a second brightness in the second sensing sequence.

In the display apparatus according to some aspects, the driver circuit sequentially may display the image patterns for each color in the sensing area in the each of the first sensing sequence and the second sensing sequence, wherein the second brightness of the image patterns for each color displayed in the sensing area in the second sensing sequence may be brighter than the first brightness of the image patterns for each color displayed in the sensing area in the first sensing sequence.

In the display apparatus according to some aspects, each of the first sensing sequence and the second sensing sequence may include a first color sensing period for sensing electrical characteristics of first color sub-pixels in the sensing area, a second color sensing period for sensing electrical characteristics of second color sub-pixels in the sensing area, and a third color sensing period for sensing electrical characteristics of third color sub-pixels in the sensing area.

In the display apparatus according to some aspects, the sensing circuit may sense electrical characteristics of the sensing area using a first sensing current flowing through sensing path in the sensing area and a second power line from the first power line in a first sensing sequence to output a first sensing data, and may sense electrical characteristics of the sensing area using a second sensing current flowing through the sensing path in the sensing area and the second power line from the first power line in the second sensing sequence to output a second sensing data.

In the display apparatus according to some aspects, the driver circuit may perform the sequence that varies sensing current, until a difference between present sensing data and previous sensing data falls within the target range by comparing the present sensing data in a present sensing mode and the previous sensing data in a previous sensing mode, and may repeat the sequence.

In the display apparatus according to some aspects, in response to the difference between the present sensing data and the previous sensing data falling within the target range by comparing the present sensing data in the present sensing mode and the previous sensing data in the previous sensing mode, the driver circuit may calculate a compensate gain for a change of electrical characteristics of sensing sub-pixels in the sensing area based on the present sensing data and stores the compensate gain in memory.

In the display apparatus according to some aspects, the driver circuit may include a power management circuit, which applies a first power voltage and the sensing current to a first power line shared by the plurality of sub-pixels of the display panel and applies a second power voltage to a second power line shared by light emitting elements of the plurality of sub-pixels, wherein the power management circuit may apply the first power voltage for the sensing mode different from the first power voltage for the display mode and may apply the second power voltage for the sensing mode different from the second power voltage for the display mode.

In the display apparatus according to some aspects, the display panel may include a plurality of sensing areas, wherein the driver circuit may sense electrical characteristics of the plurality of sensing areas for each of the sensing areas and for each color using the first sensing current in the first sensing sequence and senses electrical characteristics of the plurality of sensing areas for each of the sensing areas and for each color using the second sensing current in the second sensing sequence.

A driving method of a display apparatus according to some aspects may include sensing a sensing area of display area using first sensing current according to a first sensing sequence, determining whether first sensing data is distorted by comparing the first sensing data sensed according to the first sensing sequence of a present sensing mode and previous sensing data of a previous sensing mode, varying the first sensing current to the second sensing current, in response to determining that the first sensing data is distorted, sensing the sensing area of the display area using the second sensing current according to the second sensing sequence, and repeating a process of determining whether the second sensing data is distorted by comparing the second sensing data sensed according to the second sensing sequence and the previous sensing data, and calculating a compensate gain for a change of electrical characteristics of sensing sub-pixels in the sensing area based on the sensing data, which is determined to be normal and storing the compensate gain in memory, in response to the first sensing data or the second sensing data being determined to be normal.

The driving method of the display apparatus according to some aspects may display a same grayscale of image patterns in the sensing area in the first sensing sequence and the second sensing sequence, may display the image pattern at a first brightness in the sensing area according to the first sensing current in the first sensing sequence, and may display the image pattern at a second brightness brighter than the first brightness in the sensing area according to the second sensing current higher than the first sensing current in the second sensing sequence.

The driving method of the display apparatus according to some aspects sequentially may display the image patterns for each color in the sensing area, in the each of the first sensing sequence and the second sensing sequence, wherein the second brightness of the image patterns for each color displayed in the sensing area in the second sensing sequence is brighter than the first brightness of the image patterns for each color displayed in the sensing area in the first sensing sequence.

The driving method of the display apparatus according to some aspects, each of the first sensing sequence and the second sensing sequence may include a first color sensing period for sensing electrical characteristics of first color sub-pixels in the sensing area, a second color sensing period for sensing electrical characteristics of second color sub-pixels in the sensing area, and a third color for sensing period sensing electrical characteristics of third color sub-pixels in the sensing area.

The driving method of the display apparatus according to some aspects may sense electrical characteristics of the sensing area using the first sensing current flowing through a sensing path in the sensing area and a second power line from a first power line in the display panel in the first sensing sequence, and may sense electrical characteristics of the sensing area using the second sensing current flowing through the sensing path in the sensing area and the second power line from the first power line in the second sensing sequence.

The driving method of the display apparatus according to some aspects may vary the second sensing current, until the second sensing data of the present sensing mode is larger than the previous sensing data and falls within the target range, and may repeat a same sensing sequence as the second sensing sequence.

In the driving method of the display apparatus according to some aspects, the display panel may include a plurality of sensing areas, the driving method may sense electrical characteristics of the plurality of sensing areas for each of the sensing areas and for each color using the first sensing current in the first sensing sequence, and may sense electrical characteristics of the plurality of sensing areas for each of the sensing areas and for each color using the second sensing current in the second sensing sequence.

As described above, the display apparatus and driving method thereof according to one example embodiment may improve sensing accuracy of electrical characteristics of an light emitting element using the sensing current minimizing the influence of leakage current by repeating the sensing operation until the sensing data enters a target range with varying a sensing current applied to a display panel, thereby minimizing afterimage compensation distortion or improving afterimage compensation performance.

The display apparatus and driving method thereof according to one example embodiment may improve the afterimage compensation performance by improving the sensing accuracy of the electrical characteristics of the light emitting element by using a sensing current that minimizes the influence of leakage current, thus the afterimage lifetime of the light emitting element may be increased and a low power consumption effect may be achieved.

The above-described feature, structure, and effect of the present disclosure are included in at least one example embodiment of the present disclosure, but are not limited to only one example embodiment. Furthermore, the feature, structure, and effect described in at least one example embodiment of the present disclosure may be implemented through combination or modification of other example embodiments by those skilled in the art. Therefore, content associated with the combination and modification should be construed as being within the scope of the present disclosure.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A display apparatus, comprising:
a display panel including a plurality of sub-pixels;
a driver circuit configured to drive the display panel; and
a sensing circuit for sensing electrical characteristics of a sensing area of the display panel to output sensing data,
wherein the driver circuit is configured to perform a sequence that varies sensing current applied to a first power line until the sensing data falls within a target range in a sensing mode, and to repeat the sequence with respect to the sensing area.

2. The display apparatus of claim 1,
wherein the driver circuit is configured to apply a first sensing current to the display panel in a first sensing sequence of the sensing mode and to apply a second sensing current increased more than the first sensing current to the display panel in a second sensing sequence of the sensing mode.

3. The display apparatus of claim 2,
wherein the driver circuit is configured to provide a same grayscale of image patterns in the first sensing sequence and the second sensing sequence to the sensing area, and
wherein the sensing area is configured to display the image pattern at a first brightness in the first sensing sequence and to display the image pattern at a second brightness in the second sensing sequence.

4. The display apparatus of claim 3,
wherein the driver circuit is configured to sequentially display the image patterns for each color in the sensing area in each of the first sensing sequence and the second sensing sequence, and
wherein the second brightness of the image patterns for each color displayed in the sensing area in the second sensing sequence is for being brighter than the first brightness of the image patterns for each color displayed in the sensing area in the first sensing sequence.

5. The display apparatus of claim 4,
wherein each of the first sensing sequence and the second sensing sequence comprises:
a first color sensing period for sensing electrical characteristics of first color sub-pixels in the sensing area,
a second color sensing period for sensing electrical characteristics of second color sub-pixels in the sensing area, and
a third color sensing period for sensing electrical characteristics of third color sub-pixels in the sensing area.

6. The display apparatus of claim 1, wherein the sensing circuit is configured to sense electrical characteristics of the sensing area using a first sensing current flowing through a sensing path in the sensing area and a second power line from the first power line in a first sensing sequence to output a first sensing data, and to sense electrical characteristics of the sensing area using a second sensing current flowing through the sensing path in the sensing area and the second power line from the first power line in the second sensing sequence to output a second sensing data.

7. The display apparatus of claim 1, wherein the driver circuit is configured to perform the sequence that varies sensing current, until a difference between present sensing data and previous sensing data falls within the target range by comparing the present sensing data in a present sensing mode and the previous sensing data in a previous sensing mode, and to repeat the sequence.

8. The display apparatus of claim 7, wherein in response to the difference between the present sensing data and the previous sensing data falling within the target range by comparing the present sensing data in the present sensing mode and the previous sensing data in the previous sensing mode, the driver circuit is configured to calculate a compensate gain for a change of electrical characteristics of sensing sub-pixels in the sensing area based on the present sensing data and to store the compensate gain in a memory.

9. The display apparatus of claim 1,
wherein the driver circuit comprises a power management circuit, which is configured to apply a first power voltage and the sensing current to a first power line shared by the plurality of sub-pixels of the display panel and to apply a second power voltage to a second power line shared by light emitting elements of the plurality of sub-pixels, and
wherein the power management circuit is configured to apply the first power voltage for the sensing mode different from the first power voltage for a display mode and to apply the second power voltage for the sensing mode different from the second power voltage for the display mode.

10. The display apparatus of claim 2,
wherein the display panel includes a plurality of sensing areas, and
wherein the driver circuit is configured to sense electrical characteristics of the plurality of sensing areas for each of the sensing areas and for each color using the first sensing current in the first sensing sequence and to sense electrical characteristics of the plurality of sensing areas for each of the sensing areas and for each color using the second sensing current in the second sensing sequence.

11. The display apparatus of claim 1,
wherein the target range is a range where present sensing data of the sensing area of a present sensing mode is greater than last sensing data measured in a previous sensing mode.

12. A driving method of a display apparatus, comprising:
sensing a sensing area of a display area using a first sensing current according to a first sensing sequence;
determining whether first sensing data is distorted by comparing the first sensing data sensed according to the first sensing sequence of a present sensing mode and previous sensing data of a previous sensing mode;
varying the first sensing current to a second sensing current, in response to determining that the first sensing data is distorted;
sensing the sensing area of the display area using the second sensing current according to a second sensing sequence, and repeating a process of determining whether second sensing data is distorted by comparing the second sensing data sensed according to the second sensing sequence and the previous sensing data; and
calculating a compensate gain for a change of electrical characteristics of sensing sub-pixels in the sensing area based on the sensing data, which is determined to be normal and storing the compensate gain in a memory, in response to the first sensing data or the second sensing data being determined to be normal.

13. The driving method of the display apparatus of claim 12,
wherein a same grayscale of image patterns is displayed in the sensing area in the first sensing sequence and the second sensing sequence,
wherein the image pattern is displayed at a first brightness in the sensing area according to the first sensing current in the first sensing sequence, and
wherein the image pattern is displayed at a second brightness brighter than the first brightness in the sensing area according to the second sensing current higher than the first sensing current in the second sensing sequence.

14. The driving method of the display apparatus of claim 13,
wherein the image patterns for each color are sequentially displayed in the sensing area, in each of the first sensing sequence and the second sensing sequence, and
wherein the second brightness of the image patterns for each color displayed in the sensing area in the second sensing sequence is brighter than the first brightness of the image patterns for each color displayed in the sensing area in the first sensing sequence.

15. The driving method of the display apparatus of claim 14,
wherein each of the first sensing sequence and the second sensing sequence comprises:
a first color sensing period for sensing electrical characteristics of first color sub-pixels in the sensing area,
a second color sensing period for sensing electrical characteristics of second color sub-pixels in the sensing area, and
a third color sensing period for sensing electrical characteristics of third color sub-pixels in the sensing area.

16. The driving method of the display apparatus of claim 12, comprising:
sensing electrical characteristics of the sensing area using the first sensing current flowing through a sensing path in the sensing area and a second power line from a first power line in the display area in the first sensing sequence; and
sensing electrical characteristics of the sensing area using the second sensing current flowing through the sensing path in the sensing area and the second power line from the first power line in the second sensing sequence.

17. The driving method of the display apparatus of claim 12,
wherein the second sensing current is varied, until the second sensing data of the present sensing mode is larger than the previous sensing data and falls within a target range, and a same sensing sequence as the second sensing sequence is repeated.

18. The driving method of the display apparatus of claim 17,
wherein the target range is a range where the present sensing data of the sensing area of the present sensing mode is greater than last sensing data measured in the previous sensing mode.

19. The driving method of the display apparatus of claim 12,
wherein the display area includes a plurality of sensing areas,
wherein electrical characteristics of the plurality of sensing areas are sensed for each of the sensing areas and for each color using the first sensing current in the first sensing sequence, and
wherein electrical characteristics of the plurality of sensing areas are sensed for each of the sensing areas and for each color using the second sensing current in the second sensing sequence.
